(19) United States
(12) Patent Application Publication
(10) Pub. No.: US 2014/0264114 A1
(43) Pub. Date: Sep. 18, 2014

(54) Solenoid Valve Having One-Piece Collar-Tube

(71) Applicant: EMERSON ELECTRIC CO., St. Louis, MO (US)

(72) Inventors: Thomas Martin Farace, Marine, IL (US); David Edward Ayton, Sidney, OH (US); Douglas Michael Siefring, New Weston, OH (US); Adam Robert Roush, Saint Paris, OH (US)

(73) Assignee: EMERSON ELECTRIC CO., St. Louis, MO (US)

(21) Appl. No.: 13/834,392

(22) Filed: Mar. 15, 2013

(51) Int. Cl. F16K 31/02; B23P 15/00

(52) U.S. Cl. CPC F16K 31/02; B23P 15/001
USPC 251/129.15; 29/890.131

(57) ABSTRACT

According to various aspects, exemplary embodiments are disclosed of a one-piece collar-tube for a valve assembly. Also disclosed are valve assemblies that include a one-piece collar-tube. Also disclosed are exemplary embodiments of methods. In an exemplary embodiment, a method generally includes integrally forming a collar portion and a tube portion for a valve assembly from a non-magnetic material as a single piece having a monolothic construction.

### FIELD

The present disclosure relates to solenoid valves that have a one-piece collar-tube.

### BACKGROUND

This section provides background information related to the present disclosure which is not necessarily prior art.

Solenoid actuators are commonly used to control the flow of fluids through valves in various systems such as refrigeration systems and heating, ventilation, and air conditioning (HVAC) systems.

In operation, the solenoid actuator may be electrically actuated to cause a moveable valve member to move from a normally closed position to an open position or vice versa. In the closed position, the movable valve member or element is seated against a valve seat such that an opening defined by the valve seat is sealed or closed, to thereby prevent fluid flow through the opening. In the open position, the movable valve member or element is spaced apart from the valve seat, such that fluid flow is permitted through the opening defined by the valve seat.

### SUMMARY

This section provides a general summary of the disclosure, and is not a comprehensive disclosure of its full scope or all of its features.

According to various aspects, exemplary embodiments are disclosed of a one-piece collar-tube for a valve assembly. Also disclosed are valve assemblies that include a one-piece collar-tube. Also disclosed are exemplary embodiments of methods. In an exemplary embodiment, a method generally includes integrally forming a collar portion and a tube portion for a valve assembly from a non-magnetic material as a single piece having a monolothic construction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure

FIG. 1 is a perspective view of a solenoid valve including a one-piece collar-tube according to an exemplary embodiment;

FIG. 2 is a lower perspective view of the solenoid valve including the one-piece collar-tube shown in FIG. 1;

FIG. 3 is a top view of the solenoid valve including the one-piece collar-tube shown in FIG. 1;

FIG. 4 is a sectional view of the solenoid valve including the one-piece collar-tube take along line Z-Z in FIG. 3;

FIG. 5 is a perspective view of the one-piece collar-tube of the solenoid valve shown in FIG. 1;

FIG. 6 is a top view of the one-piece collar-tube shown in FIG. 5;

FIG. 7 is a sectional view of the one-piece collar-tube take along line Z-Z in FIG. 6;

FIG. 8 is a perspective view of a valve assembly including the one-piece collar tube shown in FIG. 1 and a solenoid disposed around the tube portion according to an exemplary embodiment;

FIG. 9 provides a summary of average open pull in test results for a conventional solenoid valve having a two-piece collar and tube that are separate components;

FIG. 10 provides a summary of average open pull in voltage test results for a solenoid valve having a one-piece collar-tube according to an exemplary embodiment;

FIG. 11 provides a summary of pull in voltage for a three trial average of a solenoid valve having a one-piece collar-tube made of 304L stainless steel according to an exemplary embodiment;

FIG. 12 provides a summary of pull in voltage for a three trial average of a solenoid valve having a one-piece collar-tube made of 304L stainless steel in which the plunger and top plug were annealed according to an exemplary embodiment; and

FIG. 13 provides a summary of pull in voltage for a three trial average of a solenoid valve having a one-piece collar-tube made of 316L stainless steel according to an exemplary embodiment.

Corresponding reference numerals indicate corresponding parts throughout the several views of the drawings.

### DETAILED DESCRIPTION

Example embodiments will now be described more fully with reference to the accompanying drawings.

With reference now to the figures, FIGS. 1 through 4 illustrate an exemplary embodiment of a solenoid operated valve 100 having a one-piece collar-tube 104 embodying one or more aspects of the present disclosure. The one-piece collar-tube 104 (broadly, a one-piece component) includes a collar (broadly, first portion) 108 and a tube (broadly, second portion) 112. The collar 108 may also be referred to as a first portion, collar portion, valve body, housing, or casing of the one-piece component or collar-tube 104. The tube 108 may be referred to as second portion or tube portion of the one-piece component or collar-tube 104.

The collar and tube portions 108, 112 are integrally formed and/or combined to thereby provide a single unitized part or piece comprising the one-piece collar-tube 104. The one-piece collar-tube 104 has a unitary, monolithic, or single component construction. In exemplary embodiments, the one-piece collar-tube 104 is formed from non-magnetic material, which helps to eliminate potential stiction that may occur in a conventional valve due to the magnetic attraction between a collar formed from magnetic material and a moveable valve member.

In this exemplary embodiment, a non-magnetic material (e.g., ASTM A276 304L stainless steel, 316L stainless steel, etc.) is used for the collar portion 108 and the tube portion 112 of the one-piece collar-tube 104. For example, the collar portion 108 and tube portion 112 may be integrally formed together from the same non-magnetic material during the same manufacturing process, such as by machining A276 304L stainless steel, etc. Accordingly, this exemplary embodiment does not require a joint (e.g., welded, brazed, or soldered joint, etc.) to join the collar and tube to each other as is typically used with conventional solenoid valves. Eliminating the joint eliminates the potential that such joint might crack and leak from vibration fatigue and costs otherwise associated with ultrasonic inspections of the joint.

As shown by FIG. 3, the one-piece collar-tube 104 includes six flat surfaces 116 defining a hexagonal portion 120. The hexagonal portion 120 is configured to allow a tool (e.g., socket wrench, other wrench, etc.) to be used for applying torque for rotating the one-piece collar-tube 104 and thus the solenoid valve 100. The collar portion 108 of the one-piece collar-tube 104 may have a threaded surface to allow the solenoid valve 100 to be threaded into an opening, for example, of a digital scroll compressor. Accordingly, the solenoid valve 100 may be considered a cartridge type screw-in valve. During an exemplary installation process, the solenoid valve 100 may be threaded or screwed into an opening of a product (e.g., a digital scroll compressor, etc.) using a wrench to grip and apply torque to the hexagonal portion 120 of the one-piece collar-tube 104.

With reference to FIG. 4, the solenoid valve 100 includes at least one outlet 124 and at least one inlet 128. In the illustrated embodiment, there is a single outlet 124 around which is concentrically one or more inlet 128 concentrically positioned around the outlet 124. One or more screen filters 132 are positioned within or adjacent the one or more inlets 128 for filtering the incoming flow of fluid.

A valve seat 136 is positioned within the collar portion 108 in the flow path between the inlet 128 and the outlet 124. A movable valve member 140 is slidably disposed in the one-piece collar tube 104, such that the moveable valve member 140 is movable relative to (towards and away from) the valve seat 136. A stop 144 is formed at or adjacent the junction between the collar and tube portions 108, 112 of the one-piece collar-tube 104. As shown in FIGS. 7 and 8, the stop 144 comprises an inwardly extending shoulder or flange portion that is circumferentially disposed around the hollow, tubular portion in which the moveable valve member 140 slides. The stop 144 is positioned for engaging the moveable valve member 140. A circumferential shoulder 148 extends around the valve member 140 to engage the stop 144. Accordingly, the stop 144 is operable for stopping continued movement (downward in FIG. 4) of the moveable valve member 140 after the circumferential shoulder 148 of the moveable valve member 140 contacts the stop 144.

A stationary core 152 is positioned and secured within the end portion of the tube 112. A spring 156 is positioned within the tube 112 for biasing the valve member 140 toward the stop 144 and valve seat 136. In this illustrated embodiment, the spring 156 is a coil spring. But other suitable biasing members or elements could be used for applying a biasing or resilient force to the valve member 140 for biasing it towards the stop 144.

As shown in FIG. 8, a solenoid 199 and its coil surrounds the tube 112. In FIG. 8, the collar portion 108 and hexagonal portion 120 of the one-piece collar-tube 104 may be seen, but the tube portion 112 is hidden from view by the solenoid 199.

The valve member 140 has a central passage 160 for receiving the spring 156. A first end portion of the spring 156 contacts a portion (e.g., an inwardly extending circumferential shoulder or flange portion, etc.) of the valve member 140, while an opposite second end portion of the spring 156 contacts the stationary core 15.

In operation, the solenoid when energized causes the valve member 140 to move against the bias of the spring 156 away from the stop 144 towards the stationary core 152. A valve element 164 is mounted on the valve member 140 with a spring 168 that resiliently biases the valve element 164 into sealing engagement with the valve seat 136 when the valve member 140 is in its closed, stopped position as shown in FIG. 4. In this illustrated embodiment, the spring 168 is a coil spring. But other suitable biasing members or elements could be used for applying a biasing or resilient force to the valve element 164 for biasing it towards the valve seat 136.

The spring 156 biases the valve member 140 against the stop 144, and the spring 168 biases the valve element 164 against the seat 136. When the solenoid is energized, the valve member 140 moves against the bias of the spring 156 away from the stop 144. This, in turn, moves the valve element 164 away from the valve seat 136 and the valve is open. In the open position, the valve element 164 is spaced apart from the valve seat 136, such that fluid can flow from the inlet 128 through the gap separating the valve element 164 from the valve seat 136 and out the outlet 124.

When the solenoid is de-energized, the spring 156 biases the valve member 140 and the valve element 164 toward the stop 144 and valve seat 136. The valve element 164 contacts the valve seat 136 and stops moving. Further movement of the valve member 140 is accommodated by the spring 168 until the valve member 140 contacts the stop 144. This contact between the valve member 140 and stop 144 arrests further movement of the valve member 140 and absorbs the impact of its movement, which helps prevent or reduce the impact from being transferred to the valve element 164 and valve seat 136. Thus, the impact force of the valve element 164 against the valve seat 136 is reduced, which, in turn, also reduces damage to the valve element 164 and valve seat 136, thereby extending the useful life of the valve 100.

The valve member 140 includes an end portion defining or including a chamber or opening 172. The chamber 172 is configured for receiving the valve element 164. The mouth of the chamber 172 has a ring 176 that engages a shoulder 180 formed on the valve element 164, for retaining the valve element 164 in the chamber 172. A passage extends inwardly from the chamber 172 for receiving the spring 168. A first end portion of the spring 168 engages the valve member 140, and the second or other end portion of the spring 168 engages the valve element 164. The spring 168 biases the valve element 164 toward the valve seat 136 while the ring 176 engages the shoulder 180 on the valve element 164 to retain the valve element 164 in the chamber 172 of the valve member 140.

The valve element 164 sealingly engages the valve seat 136 in a closed position when the solenoid is not actuated. When the solenoid is actuated, the valve member 140 moves away from the stop 144 and the valve seat 136. As the valve member 140 moves, the ring 176 engages the valve element 164 and pulls it away from the valve seat 136. The initial movement of the valve member 140 before the valve element 164 moves provides an impact to the valve element 164 that helps unseat the valve element 164. As described above, when the solenoid is de-actuated the spring 156 moves the valve member 140 toward the valve seat 136. The valve element 164 contacts the valve seat 136, and further movement of the valve member 140 under the bias of spring 156 is accommodated by the spring 168. The shoulder 148 on the valve member 140 eventually engages the stop 144, stopping further movement of the valve member 140 and absorbing impact. Thus, while the valve member 140 has an effective mass to be operated by the solenoid and to close the valve quickly when the solenoid is de-actuated, the valve element 164 is shielded from the brunt of the impact of the valve member 140 moving toward its closed position, thereby preserving the life of the valve element 164 and the valve seat 136.

With continued reference to FIG. 4, the solenoid valve 100 also includes a cartridge 184 defining or including the outlet 124, the inlet 128, and the valve seat 136. The cartridge 184 also defines or includes an inner circular channel 188 for mounting an O-ring 192, which can sealingly separate the outlet 124 and the inlet 128. The solenoid valve 100 also has an O-ring 196 disposed circumferentially about the bottom edge portion of the cartridge 184 and generally underneath the bottom edge portion of the collar 108. The collar portion 108 of the one-piece collar-tube 104 may have a threaded surface 198 to allow the solenoid valve 100 to be threaded into an opening, for example, in a digital scroll compressor by using a wrench to grip and apply torque to the hexagonal portion 120 of the one-piece collar-tube 104.

FIG. 10 provides average open pull in test results for a solenoid valve having a one-piece collar-tube. For comparison purposes, pull in testing was also performed on a conventional solenoid valve having a collar and a tube that are separate components. FIG. 9 show the average open pull in test results for the conventional solenoid valve having the two-piece collar and tube. Generally, the test results show the improved performance that may be achieved by using a one-piece collar-tube in a solenoid valve as compared to using a conventional two piece collar and tube in a solenoid valve. These pull in test results are provided only for purposes of illustration and not for purposes of limitation.

Generally, pull in refers to the minimum voltage required to open the valve. In these examples, the pull in testing was performed to determine the voltage required to open a digital valve. For the pull in testing, the testing occurred at 150 pounds per square inch (PSI) with a starting voltage of 30 volts with the solenoid valve in a normally closed position. Then, the voltage was increased by 1 volt every 5 seconds. The solenoid valve was turned off between cycles with a zero cross relay switch until the solenoid valve fully opened. To pass the test, there must be a full flow through the solenoid valve without any chattering, and the solenoid valve must open three times without chattering.

The data shown in the line graph of FIG. 9 obtained from the average open pull in test results for the conventional solenoid valve having the two-piece collar and tube is quantified or summarized below:

### Anderson-Darling Normality Test: A-Squared 2.13 and P-Value<0.005

### Mean 91.015

### Standard Deviation 8.310

### Variance 69.055

### Skewness −1.26177

### Kurtosis 3.21894

### N 67

### Minimum 60.333

### 1^{st} Quartile 89.000

### Median 91.333

### 3^{rd} Quarter 96.333

### Maximum 111.333

### 95% Confidence Interval for Mean 88.988 93.042

### 95% Confidence Interval for Median 90.667 93.339

### 95% Confidence Interval for Standard Deviation 7.102 10.016

The data shown in the line graph of FIG. 10 obtained from the average open pull in test results for the solenoid valve having the one-piece collar-tube is quantified or summarized below:

### Anderson-Darling Normality Test: A-Squared 1.31 and P-Value<0.005

### Mean 76.640

### Standard Deviation 7.097

### Variance 50.361

### Skewness 1.08972

### Kurtosis 3.02556

### N 120

### Minimum 62.500

### 1^{st} Quartile 71.192

### Median 76.833

### 3^{rd} Quarter 79.933

### Maximum 105.5

### 95% Confidence Interval for Mean 75.357 77.923

### 95% Confidence Interval for Median 75.027 77.780

### 95% Confidence Interval for Standard Deviation 6.298 8.129

FIG. 11 provides a summary of pull in voltage for a three trial average of a solenoid valve having a one-piece collar-tube made of 304L stainless steel according to an exemplary embodiment. The data in the line graph of FIG. 11 has a mean of 78.5417, a standard deviation (within) of 7.1132, a standard deviation (overall) of 7.42095, and a sample N of 165.

FIG. 12 provides a summary of pull in voltage for a three trial average of a solenoid valve having a one-piece collar-tube made of 304L stainless steel in which the plunger and top plug (e.g., movable valve member 140 and stationary core 152, etc.) were annealed according to an exemplary embodiment. The data in the line graph of FIG. 12 has a mean of 66.9846, a standard deviation (within) of 2.48267, a standard deviation (overall) of 2.81955, and a sample N of 23. A comparison of FIGS. 11 and 12 show that annealing the plunger and the top plug yields a significant improvement, e.g., a mean of 66.9846 (FIG. 12) versus a mean of 78.5417 (FIG. 11).

FIG. 13 provides a summary of pull in voltage for a three trial average of a solenoid valve having a one-piece collar-tube made of 316L stainless steel according to an exemplary embodiment. The data in the line graph of FIG. 13 has a mean of 75.7471, a standard deviation (within) of 8.10175, a standard deviation (overall) of 9.95104, and a sample N of 50.

Generally, a comparison of the test results in FIGS. 10-13 with the test results in FIG. 9 shown that improved performance may be achieved by using a one-piece collar-tube in a solenoid valve as compared to using a conventional two piece collar and tube in a solenoid valve. These test results are provided only for purposes of illustration and not for purposes of limitation.

Exemplary embodiments disclosed herein may provide one or more (but not necessarily any or all) of the following advantages as compared to some existing solenoid valves. For example, some existing solenoid valves include a tube and collar that are discreet separate components formed from different materials brazed, soldered, or welded to each other. While such existing solenoid valves may work well for their intended applications, the inventors have recognized that valve performance might be improved by using a one-piece collar-tube instead of a two-piece collar and tube that are joined together.

The inventors have recognized that using a one-piece collar-tube that is a unitized or single part advantageously eliminates the joint (e.g., welded, brazed, or soldered joint, etc.) that would otherwise be used between the collar and tube. In turn, eliminating the joint also eliminates the potential that such joint might crack and leak from vibration fatigue. Eliminating the joint also eliminates the costs otherwise associated with ultrasonic inspections of the joint. By eliminating the potential source of a leak, a valve including a one-piece collar-tube may also be environmentally friendly and/or environmentally compliant.

The inventors have also recognized that better magnetic performance for a valve may be obtained by selecting and using a non-magnetic material (e.g., 304L stainless steel, 316L stainless steel, etc.) for both the collar and tube portions of the one-piece collar-tube. For example, an exemplary embodiment includes a collar and tube integrally formed together from the same non-magnetic material during the same manufacturing process, such as by machining 304L stainless steel, etc.

The use of a non-magnetic material for the one-piece collar-tube helps eliminate stiction that might otherwise occur due to magnetic attraction between the collar and the moveable valve member. For example, some existing solenoid valves have a collar formed from a magnetic material such that there is magnetic attraction between the collar and the moveable valve member when the solenoid coil is energized. This magnetic attraction creates a sticking condition or stiction that must be overcome and can increase the difficulty of pulling the valve member.

The inventors hereof have recognized that it would be advantageous to eliminate this stiction or magnetic attraction especially in large commercial scale HVAC systems or refrigeration systems. For example, some large commercial scale refrigeration systems may have 100% cycling that occurs almost continuously (e.g., every 15 seconds, etc.) via a digital controlled compressor for temperature consistency. After recognizing that this magnetic attraction or stiction might be problematic with almost continuous 100% cycling, the inventors sought to develop a solution for eliminating the magnetic attraction or stiction. Accordingly, the inventors developed and have disclosed herein exemplary embodiments having a one-piece collar-tube formed entirely from non-magnetic material, thereby eliminating the magnetic attraction and stiction problems mentioned above. The non-magnetic one-piece collar-tube may be particularly useful, for example, in a solenoid valve for a large commercial scale HVAC system or refrigeration system. In which case, the refrigeration system may thus be better able to maintain a consistent temperature and have improved temperature consistency due to the elimination of the stiction, such as during the almost continuous (e.g., every 15 seconds, etc.) 100% cycling associated with some refrigeration systems.

Notably, there are usually increased costs associated with non-magnetic material as compared to magnetic material. Moreover, conventional solenoid valves having a two-piece collar and tube are considered to be a fully mature technology, which means it can be very costly and cost prohibitive to try to improve let alone actually improve upon such a mature technology. These hurdles notwithstanding, the inventors proceeded forward anyway and were able to improve valve performance by using a collar and a tube formed as a single piece from non-magnetic material (e.g., a non-magnetic material having a magnetic permeability of 1.02 or less, etc.). By way of example only, the non-magnetic material may be ASTM A276 304L stainless steel. By way of further example, the non-magnetic material may be 316L stainless steel in other exemplary embodiments.

In addition, some exemplary embodiments may include a collar and a tube formed as a single piece from non-magnetic material (e.g., 304L stainless steel, 316L stainless steel, etc.) where portions of the non-magnetic material are annealed. For example, an exemplary embodiment includes a collar and a tube formed as a single piece from 304L stainless steel where the plunger and top plug have been annealed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A valve assembly comprising:
a one-piece collar-tube including a collar portion and a tube portion;
an inlet;
an outlet;
a valve seat disposed within the collar portion in the flow path between the inlet and the outlet;
a stationary core disposed within the tube portion;
a moveable valve member disposed within the one-piece collar-tube and moveable relative to the valve seat;
a biasing element disposed within the tube portion for resiliently biasing the moveable valve member relative to the valve seat; and
a solenoid disposed around the tube portion, the solenoid operable for moving the valve member relative to the valve seat against the bias of the biasing element.

2. The valve assembly of claim 1, wherein the collar portion and tube portion are integrally formed from non-magnetic material such that the one-piece collar-tube has a monolithic construction of the non-magnetic material.

3. The valve assembly of claim 1, wherein the one-piece collar-tube comprises ASTM A276 304L or 316L stainless steel.

4. The valve assembly of claim 1, wherein the one-piece collar-tube has a monolithic construction without any welded, soldered, or brazed joints connecting the collar portion to the tube portion.

5. The valve assembly of claim 1, wherein:
the valve assembly further comprises a cartridge the includes or defines the inlet, the outlet, and the valve seat; and
the cartridge is disposed within the collar portion.

6. The valve assembly of claim 3, wherein the collar portion of the one-piece collar-tube includes a threaded surface to allow the valve assembly to be threaded into a correspondingly threaded opening of a digital scroll compressor.

7. The valve assembly of claim 1, wherein the biasing element is a coil spring that resiliently biases the moveable valve member towards the valve seat such that the valve assembly is closed when the solenoid is not energized, whereby activation of the solenoid moves the valve member away from valve seat against the bias of the coil spring to thereby open the valve assembly.

8. The valve assembly of claim 1, wherein:
the one-piece collar tube includes a stop above the valve seat for engaging the valve member;
the biasing element is operable for resiliently biasing the valve member towards a closed position against the stop;
a valve element movably mounted to the valve member;
a second biasing element operable for resiliently biasing the valve element away from the valve member to sealingly engage the valve seat when the valve member is in its closed position; and
the solenoid is operable for moving the valve member against the bias of the biasing element from the closed position against the stop to an open position away from the stop, whereby activation of the solenoid moves the valve member away from the stop and causes the valve element to move away from the valve seat.

9. A digital scroll compressor comprising the valve assembly of claim 1.

10. A one-piece collar-tube for a valve assembly, the one-piece collar-tube including a collar portion and a tube portion integrally formed from non-magnetic material such that the one-piece collar-tube has a monolithic construction.

11. The one-piece collar-tube of claim 10, wherein the collar and tube portions comprise ASTM A276 304L or 316L stainless steel.

12. The one-piece collar-tube of claim 10, wherein the one-piece collar-tube has a monolithic construction without any welded, soldered, or brazed joints connecting the collar portion to the tube portion.

13. A digital scroll compressor comprising the one-piece collar-tube of claim 10.

14. A method comprising integrally forming a collar portion and a tube portion for a valve assembly from a non-magnetic material as a single piece having a monolothic construction without any welded, soldered, or brazed joints connecting the collar portion to the tube portion.

15. The method of claim 14, wherein the non-magnetic material comprises ASTM A276 304L or 316L stainless steel.

16. The method of claim 14, wherein integrally forming comprising matching the non-magnetic material to thereby provide a single machined piece that includes the collar portion and the tube portion.

17. The method of claim 14, wherein integrally forming comprising matching ASTM A276 304L or 316L stainless steel to thereby provide a single machined piece that includes the collar portion and the tube portion.

18. The method of claim 14, wherein the collar portion and tube portion are configured for use in a digital scroll compressor solenoid valve.

19. The method of claim 14, further comprising assembling a valve assembly by positioning:
a cartridge within the collar portion that includes or defines an inlet, an outlet, and a valve seat such that the valve seat is in the flow path of the valve assembly between the inlet and the outlet;
a stationary core within the tube portion;
a moveable valve member within the collar and tube portions; and
at least one biasing element within the tube portion.
